(19) United States
(12) Patent Application Publication
(10) Pub. No.: US 2024/0418090 A1
(43) Pub. Date: Dec. 19, 2024

(54) ELECTROMAGNETIC WAVE ABSORPTION TECHNOLOGY-BASED MULTIFUNCTIONAL HEATING SANDWICH COMPOSITE MATERIAL APPLICABLE TO LARGE WING STRUCTURE, AND METHOD FOR MANUFACTURING SAME

(71) Applicant: Industry-Academic Cooperation Foundation Gyeongsang National University, Gyeongsangnam-do (KR)

(72) Inventors: Young Woo Nam, Gyeonggi-do (KR); Jin Hwe KWEON, Gyeongsangnam-do (KR); Byeong Su KWAK, Gyeongsangnam-do (KR); Hyeon Seok CHOE, Jeju-do (KR); Ji Sub NOH, Gyeongsangnam-do (KR); Chang Min SEOK, Gyeonggi-do (KR)

(73) Assignee: Industry-Academic Cooperation Foundation Gyeongsang National University, Gyeongsangnam-do (KR)

(21) Appl. No.: 18/688,556

(22) PCT Filed: Nov. 18, 2021
(86) PCT No.: PCT/KR2021/017027

§ 371 Date: Aug. 29, 2024

(30) Foreign Application Priority Data
Sep. 3, 2021 (KR) 10-2021-0117733

(51) Int. Cl. F01D 5/28; B32B 3/12; B32B 5/02; B32B 15/14; B64D 15/12; F03D 80/40

(52) U.S. Cl. CPC F01D 5/282; B32B 3/12; B32B 5/02; B32B 15/14; B32B 2250/40; B32B 2255/02; B32B 2255/205; B32B 2262/103; B32B 2307/204; B32B 2307/7376; B32B 2603/00; B32B 2605/18; B64D 15/12; F03D 80/40; F05D 2250/283; F05D 2300/603

(57) ABSTRACT

The present disclosure relates to a multi-functional heating sandwich composite based on electromagnetic wave absorption technology applicable to large wing structures and a method for manufacturing the same, and particularly, to a composite based on an electromagnetic wave absorption heating mechanism, which converts electromagnetic waves into thermal energy in order to solve the freezing problem, and a method for manufacturing the same. The present disclosure provides a multi-functional heating sandwich composite based on electromagnetic wave absorption technology applicable to large wing structures, including: a face skin formed to a predetermined thickness on the top or bottom of the composite to absorb electromagnetic waves applied from the outside; and a honeycomb core that converts the power loss of electromagnetic waves penetrating from the face skin into thermal energy and is formed in the shape of a hexagonal pillar with a predetermined thickness using metal electroless plated dielectric fibers having electrical conductivity, wherein the honeycomb core reduces reflected electromagnetic waves by dissipating the electromagnetic waves through periodic changes in impedance in a preset target frequency band.

### TECHNICAL FIELD

The present disclosure relates to a multi-functional heating sandwich composite based on electromagnetic wave absorption technology applicable to large wing structures and a method for manufacturing the same, and particularly, to a composite based on an electromagnetic wave absorption heating mechanism, which converts electromagnetic waves into thermal energy in order to solve the freezing problem, and a method for manufacturing the same.

### BACKGROUND ART

When structures such as aircraft are exposed to extreme environments, the surface may freeze, causing problems such as increased drag, loss of lift, decreased flight performance, and casualties occurred. Conventionally, chemical or mechanical methods have been used to prevent the surface of structures such as aircraft from freezing.

Methods of removing ice using chemical or mechanical methods have the disadvantage of requiring continuous maintenance and increasing the weight of structures such as aircraft. Therefore, research is needed on a method of removing a frozen object using a heating element that does not require continuous maintenance and does not increase the weight of structures such as aircraft.

In this regard, Korean Patent Publication No. 1995-7001653 discloses an invention for treating the surface of an aircraft with an anti-icing fluid containing a polymer thickener containing hydrophobic macromonomers.

However, the method currently being researched is, as an electrothermal method, a method that generates heat by using surface-modified carbon fiber or by applying electricity to a composite with conductive nanoparticles dispersed in resin. Such a method has limitations in that mechanical and electrical properties are heterogeneous, and fabrication is difficult.

### DISCLOSURE

### Technical Problem

In order to solve the above-described problems, an object of the present disclosure is to provide a multi-functional heating sandwich composite based on electromagnetic wave absorption technology that is capable of high-speed heat control and selective heating and can be applied to large wing structures including wind generator blades, aircraft wing structures, helicopter rotor blades, etc., and a method for manufacturing the same.

### Technical Solution

In order to achieve the above object, the present disclosure provides a multi-functional heating sandwich composite based on electromagnetic wave absorption technology applicable to large wing structures, the composite including: a face skin formed to a predetermined thickness on the top or bottom of the composite to absorb electromagnetic waves applied from the outside; and a honeycomb core that converts the power loss of electromagnetic waves penetrating from the face skin into thermal energy and is formed in the shape of a hexagonal pillar with a predetermined thickness using metal electroless plated dielectric fibers having electrical conductivity, wherein the honeycomb core reduces reflected electromagnetic waves by dissipating the electromagnetic waves through periodic changes in impedance in a preset target frequency band.

According to an embodiment, the face skin may include: a top face skin installed on the top of the honeycomb core; and a bottom face skin installed on the bottom of the honeycomb core.

According to an embodiment, the top face skin may be formed to a width of 100 mm×a length of 100 mm×a thickness of 1.51 mm, the honeycomb core may be formed to a width of 100 mm×a length of 100 mm×a thickness of 10.01 mm, and the bottom face skin may be formed to a width of 100 mm×a length of 100 mm×a thickness of 1.51 mm.

According to an embodiment, the honeycomb core includes a plurality of cells in the form of hexagonal columns, and the cells may have a wall thickness of 0.25 mm and be formed to a width of 6 mm×a length of 10.01 mm.

According to an embodiment, the dielectric fibers may be electroless plating-coated to a thickness thinner than the skin depth using at least one metal of nickel (Ni), iron (Fe), and cobalt (Co).

Furthermore, the present disclosure provides a method for manufacturing multi-functional heating sandwich composite based on electromagnetic wave absorption technology applicable to large wing structures, the method including steps of: stacking a plurality of metal electroless plated dielectric fibers so that they absorb electromagnetic waves applied from the outside and thus processing the plurality of metal electroless plated dielectric fibers to have a predetermined width, and fabricating a honeycomb core by performing autoclave curing at a temperature of 130° C. or higher and for 2 hours or more after stacking the dielectric fibers on a hexagonal mold; forming a face skin by performing autoclave curing at a temperature of 130° C. or higher and in an environment of 7 atmospheric pressures or higher for 2 hours or more after stacking the plurality of metal electroless plated dielectric fibers; and bonding the face skin to the top or bottom of the honeycomb core.

According to an embodiment, the face skin may include: a top face skin installed on the top of the honeycomb core; and a bottom face skin installed on the bottom of the honeycomb core, wherein the top face skin may be formed to a width of 100 mm×a length of 100 mm×a thickness of 1.51 mm, the honeycomb core may be formed to a width of 100 mm×a length of 100 mm×a thickness of 10.01 mm, and the bottom face skin may be formed to a width of 100 mm×a length of 100 mm×a thickness of 1.51 mm.

According to an embodiment, the temperature control of the composite can be performed by adjusting the distance between an antenna of the composite and the composite, and only an area where electromagnetic waves are absorbed may be heated.

### Advantageous Effects

According to the present disclosure having the configuration described above, there is an advantage in that the composite may be manufactured lightly by having a honeycomb core structure.

In addition, since the honeycomb core composite of the present disclosure generates heat only in the area that absorbs electromagnetic waves, it provides the effect capable of generating heat by selecting the area in need of heating.

In addition, the composite of the present disclosure has the advantage of maintaining Structural robustness according to exposure to electromagnetic waves.

### BRIEF DESCRIPTION OF DRAWINGS

FIG. 1 shows detailed shapes of a multi-functional heating sandwich composite (a) and a honeycomb core (b) according to an embodiment of the present disclosure.

FIG. 2 shows a schematic diagram of a multi-functional heating sandwich composite applicable to large wing structures.

FIG. 3 shows the heating principle of the multi-functional heating sandwich composite.

FIG. 4 shows a modeling design diagram of a unit shape for optimal shape design for determining the thickness of the face skin according to an embodiment of the present disclosure.

FIG. 5 shows radio wave absorption performance (a) according to the honeycomb core wall thickness, power loss density (b) according to the honeycomb core wall thickness, radio wave absorption performance (c) according to the length of one surface of the honeycomb core, power loss density (d) according to the length of one surface of the honeycomb core, radio wave absorption performance (e) according to the honeycomb core thickness, and power loss density (f) according to the honeycomb core thickness, as matters related to the shape design of the honeycomb core according to an embodiment of the present disclosure.

FIG. 6 shows electromagnetic wave absorption performance (a) according to thicknesses of the top and bottom face skins and the honeycomb core, and power loss density (b) according to thicknesses of the top and bottom face skins and the honeycomb core according to an embodiment of the present disclosure.

FIG. 7 shows an electromagnetic wave analysis model and electromagnetic wave analysis results of a metal electroless plated dielectric fiber according to an embodiment of the present disclosure (a), t_{metallic-plated}>δ (b), and t_{metallic-plated}<δ (c).

FIG. 8 shows a metal electroless plating process (a), an SEM image (b) of metal electroless plated dielectric fibers, EDS analysis results (c) of the metal electroless plated dielectric fibers, and XPS analysis results (d) of dielectric fibers depending on whether there is metal electroless plating or not, according to an embodiment of the present disclosure.

FIG. 9 shows coaxial tube equipment configuration and specimen shape (a) according to an embodiment of the present disclosure, and complex permittivity of the dielectric fiber (b) depending on whether there is metal electroless plating or not.

FIG. 10 shows a flowchart of a method for manufacturing a multi-functional heating sandwich composite based on electromagnetic wave absorption technology applicable to large wing structures, according to an embodiment of the present disclosure.

FIG. 11 shows a process for fabricating a multi-functional heating sandwich composite based on electromagnetic wave absorption technology applicable to large wing structures, according to an embodiment of the present disclosure.

FIG. 12 shows an electromagnetic wave generator and heating test setup according to an embodiment of the present disclosure.

FIG. 13 shows temperature changes over time of a multi-functional heating sandwich composite structure according to an embodiment of the present disclosure.

FIG. 14 shows heating analysis results and heating test results according to the distance between the antenna and the multi-functional heating sandwich composite according to an embodiment of the present disclosure.

FIG. 15 shows test setup and failure mode (a) according to an embodiment of the present disclosure, and compressive strength (b) of the multi-functional heating sandwich composite depending on whether there is a heating test or not.

### BEST MODE

In order to achieve the above object, the present disclosure provides a multi-functional heating sandwich composite based on electromagnetic wave absorption technology applicable to large wing structures, the composite including: a face skin formed to a predetermined thickness on the top or bottom of the composite to absorb electromagnetic waves applied from the outside; and a honeycomb core that converts the power loss of electromagnetic waves penetrating from the face skin into thermal energy and is formed in the shape of a hexagonal pillar with a predetermined thickness using metal electroless plated dielectric fibers having electrical conductivity, wherein the honeycomb core reduces reflected electromagnetic waves by dissipating the electromagnetic waves through periodic changes in impedance in a preset target frequency band.

According to an embodiment, the face skin may include: a top face skin installed on the top of the honeycomb core; and a bottom face skin installed on the bottom of the honeycomb core.

According to an embodiment, the top face skin may be formed to a width of 100 mm×a length of 100 mm×a thickness of 1.51 mm, the honeycomb core may be formed to a width of 100 mm×a length of 100 mm×a thickness of 10.01 mm, and the bottom face skin may be formed to a width of 100 mm×a length of 100 mm×a thickness of 1.51 mm.

According to an embodiment, the honeycomb core includes a plurality of cells in the form of hexagonal columns, and the cells may have a wall thickness of 0.25 mm and be formed to a width of 6 mm×a length of 10.01 mm.

According to an embodiment, the dielectric fibers may be electroless plating-coated to a thickness thinner than the skin depth using at least one metal of nickel (Ni), iron (Fe), and cobalt (Co).

Furthermore, the present disclosure provides a method for manufacturing a multi-functional heating sandwich composite based on electromagnetic wave absorption technology applicable to large wing structures, the method including steps of: stacking a plurality of metal electroless plated dielectric fibers so that they absorb electromagnetic waves applied from the outside and thus processing the plurality of metal electroless plated dielectric fibers to have a predetermined width, and fabricating a honeycomb core by performing autoclave curing at a temperature of 130° C. or higher and for 2 hours or more after stacking the dielectric fibers on a hexagonal mold; forming a face skin by performing autoclave curing at a temperature of 130° C. or higher and in an environment of 7 atmospheric pressures or higher for 2 hours or more after stacking the plurality of metal electroless plated dielectric fibers; and bonding the face skin to the top or bottom of the honeycomb core.

According to an embodiment, the face skin may include: a top face skin installed on the top of the honeycomb core; and a bottom face skin installed on the bottom of the honeycomb core, wherein the top face skin may be formed to a width of 100 mm×a length of 100 mm×a thickness of 1.51 mm, the honeycomb core may be formed to a width of 100 mm×a length of 100 mm×a thickness of 10.01 mm, and the bottom face skin may be formed to a width of 100 mm×a length of 100 mm×a thickness of 1.51 mm.

According to an embodiment, the temperature control of the composite can be performed by adjusting the distance between the antenna of the composite and the composite, and only the area where electromagnetic waves are absorbed may be heated.

### MODE FOR INVENTION

Hereinafter, terms used in this specification will be briefly explained, and the configuration and operation of a preferred embodiment of the present disclosure will be described in detail as specific details for carrying out the present disclosure.

The terms used in this specification have selected general terms that are currently widely used as much as possible while considering the function in the present disclosure, but this may vary depending on the intention or precedent of a person skilled in the art, the emergence of new technology, etc. In addition, in specific cases, there are also terms arbitrarily selected by the applicant, and in this case, the meaning will be described in detail in the description of the relevant invention. Therefore, the terms used in the present disclosure should be defined based on the meanings of the terms and the overall contents of the present disclosure, rather than simply the names of the terms.

When it is said that a part “includes” a certain element throughout the specification, this means that, unless specifically stated to the contrary, it does not exclude other elements but may further include other elements. In addition, terms such as “ . . . unit” and “module” described in the specification refer to a unit that processes at least one function or operation, which may be implemented as hardware or software, or as a combination of hardware and software. In addition, when a part is said to be “connected” to another part throughout the specification, this includes not only cases where it is “directly connected thereto,” but also cases where it is connected thereto “with another component being in the middle therebetween.”

Below, embodiments of the present disclosure will be described in detail so that those skilled in the art to which the present disclosure pertains can easily implement the present disclosure with reference to the attached drawings. However, the present disclosure may be implemented in many different forms and is not limited to the embodiments described herein. In addition, parts not related to the description are omitted, and similar parts are given similar reference numerals throughout the specification in order to clearly explain the present disclosure in the drawings.

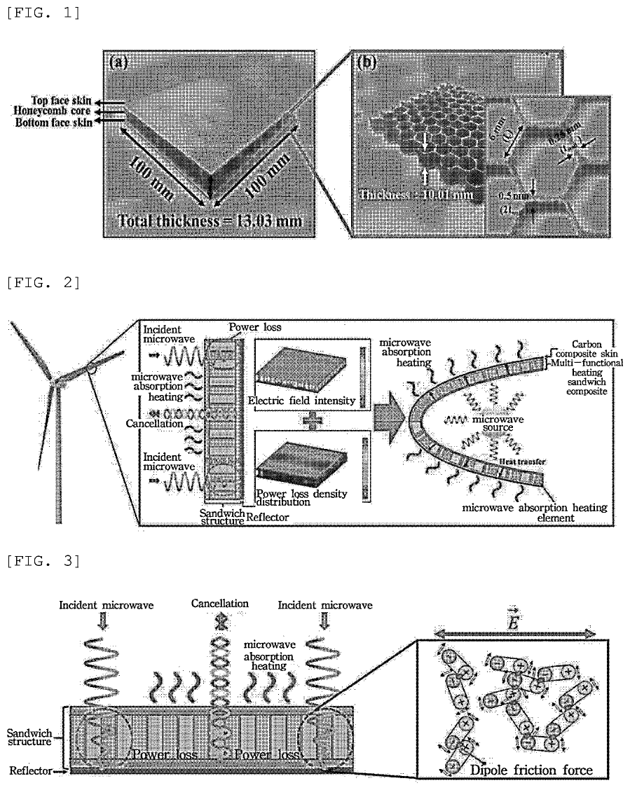

FIG. 1 shows detailed shapes of a multi-functional heating sandwich composite (a) according to an embodiment of the present disclosure and a honeycomb core (b).

Referring to FIG. 1, the multi-functional heating sandwich composite according to an embodiment of the present disclosure is composed of a face skin and a honeycomb core, and the face skin is formed by joining a top face skin and a bottom face skin based on the honeycomb core.

The face skin may be composed of: a top face skin installed on the top of the honeycomb core; and a bottom face skin installed on the bottom of the honeycomb core.

The face skin may be formed to a predetermined thickness on the top or bottom of the composite so that electromagnetic waves applied from the outside are absorbed, and the honeycomb core may convert the power loss of electromagnetic waves penetrating from the face skin into thermal energy and may be formed in the form of a hexagonal pillar with a predetermined thickness using a metal electroless plated dielectric fiber with electrical conductivity.

In particular, the honeycomb core may reduce reflected electromagnetic waves by dissipating the electromagnetic waves through periodic changes in impedance in a preset target frequency band.

FIG. 2 shows a schematic diagram of a multi-functional heating sandwich composite applicable to large wing structures.

Referring to FIG. 2, the configuration of the composite of the present disclosure is schematically shown, and the present disclosure consists of a multi-functional heating sandwich composite applicable to large wing structures including wind power generator blades, aircraft wing structures, helicopter rotor blades, etc.

The present disclosure is implemented through the principle of reducing reflected electromagnetic waves by slowly dissipating electromagnetic waves through periodic or gradual changes in impedance while inducing hysteresis in the structure by applying ultra-high frequencies to a multi-functional heating sandwich composite structure fabricated of dielectric fibers. At this time, the relevant effect may be increased by performing metal electroless plating on the dielectric fiber.

Here, the dielectric fiber may be coated electroless plating-coated thinner than the skin depth using at least one metal of nickel (Ni), iron (Fe), and cobalt (Co).

FIG. 3 shows the heating principle of the multi-functional heating sandwich composite.

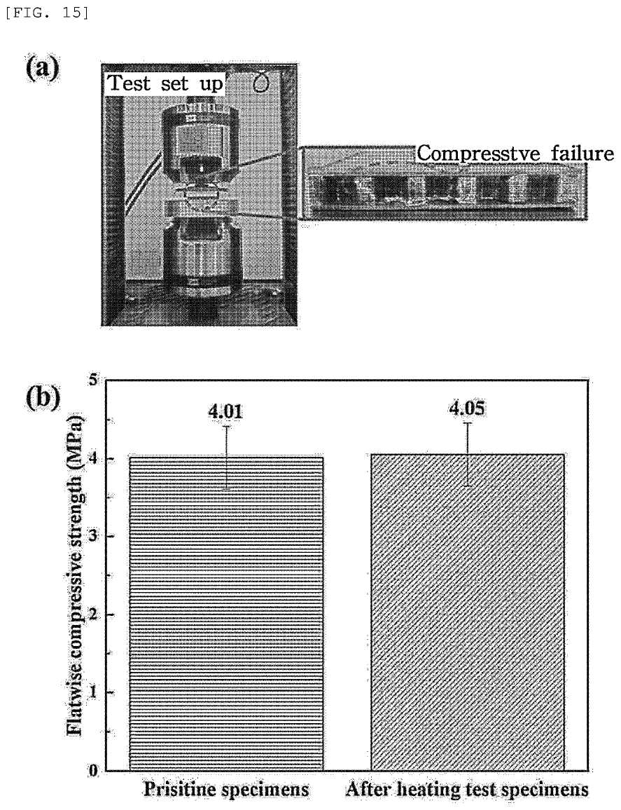

Referring to FIG. 14, the temperature control of the composite may be performed by adjusting the distance between the antenna of the composite and the composite, and only the area where electromagnetic waves are absorbed may generate heat.

The present disclosure is implemented through the principle of reducing reflected electromagnetic waves by slowly dissipating electromagnetic waves through periodic or gradual changes in impedance while inducing hysteresis in the structure by applying ultra-high frequencies to a multi-functional heating sandwich composite structure fabricated of dielectric fibers. At this time, the relevant effect is increased by performing metal electroless plating on the dielectric fiber.

The heating principle of the present disclosure converts the power loss into thermal energy by maximizing power loss generated as electromagnetic waves incident on a multi-functional heating sandwich composite structure are absorbed into the structure. In detail, when external electromagnetic waves are applied to a dielectric loss material, the dipoles inside the dielectric material are aligned by the external electromagnetic field so that polarization occurs.

Since external electromagnetic waves continuously change phase, the direction of polarization continuously changes. Due to this, collision and friction between dipoles inside the dielectric material are caused to generate heat. Heating of a multi-functional heating sandwich composite structure is implemented by controlling power loss by maximizing such dielectric heating with a multi-functional composite material with electromagnetic wave absorption performance.

In the present disclosure, the amount in which power loss generated as electromagnetic waves reflected by slowly dissipating electromagnetic waves through periodic or gradual changes in impedance are reduced is changed into thermal energy is derived through the following Mathematical Equation.

$$\\ \begin{matrix}P = 0.556 {f}_{{ε}_{r}} tan δ \times {E}^{{}_{} 2} \times {10}^{{}_{} - 12} & [ Mathematical Equation 1 ]\end{matrix}$$

(Here, P is the power (W/cm³) absorbed by the material per unit volume, f is the frequency (Hz) of the microwaves, ε, is the real part (dimensionless) in the complex permittivity of the material, tan δ is the ratio (dimensionless) of the imaginary and real parts of the complex permittivity, and E represents the electric field intensity (V/cm).)

The present disclosure includes designing and fabricating a multi-functional heating sandwich composite structure with maximized efficiency in the 2.45 GHz band, performing heating and mechanical property evaluation, and verifying the heating test through multi-physics analysis.

The present disclosure includes a heating test and heating performance of applying electromagnetic waves with a frequency of 2.45 GHz and a power of 500 W to a multi-functional heating sandwich composite structure. As a result of the heating test, the surface temperature of the multi-functional heating sandwich composite structure increased from 27.97° C. to 160.06° C. in 1700 seconds, and the temperature increase rate was 0.50° C./s up to 100° C.

Through electromagnetic-thermal multi-physics analysis, the temperature of the structure decreases as the distance between the antenna and the multi-functional heating sandwich composite increases. Therefore, the present disclosure includes a multi-functional heating sandwich composite structure capable of temperature control by adjusting the distance between the antenna and the multi-functional heating sandwich composite.

Since the multi-functional heating sandwich composite generates heat only in the area where electromagnetic waves are absorbed, and thus the desired area can selectively generate heat, the present disclosure includes a multi-functional heating sandwich structure capable of selectively generating heat.

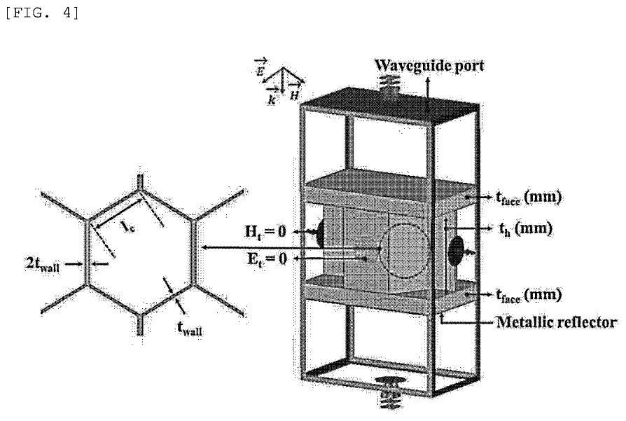

Hereinafter, FIGS. 4 to 6 explain the process of extracting the optimal shape according to the modeling design drawing.

The design of the multi-functional heating sandwich composite was conducted in two stages.

The honeycomb core shape was designed in the first stage, and the thickness of the face skin of the sandwich composite was selected in the second stage.

The target frequency band is 2.45 GHZ, and the design goals are excellent electromagnetic wave absorption performance and power loss density. This is because the heating principle of the multi-functional heating sandwich converts the power loss generated as the electromagnetic waves that are reflected by slowly dissipating electromagnetic waves through periodic or gradual changes in impedance are reduced into thermal energy. Therefore, electromagnetic wave absorption performance and power loss density were set as the design goals.

In particular, since electromagnetic wave absorption performance is affected by the shape of the multi-functional heating sandwich composite, an optimization design for the physical shape was performed. The design utilized CST STUDIO, an electromagnetic wave analysis program. To design a multi-functional heating sandwich composite, the unit shape (unit-cell) of the multi-functional heating sandwich composite considering the electromagnetic boundary condition and electromagnetic wave incident direction was modeled and shown in FIG. 4.

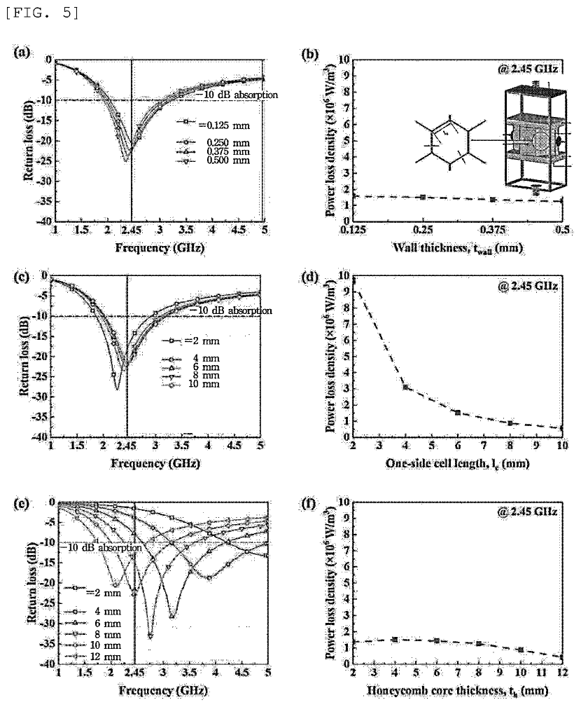

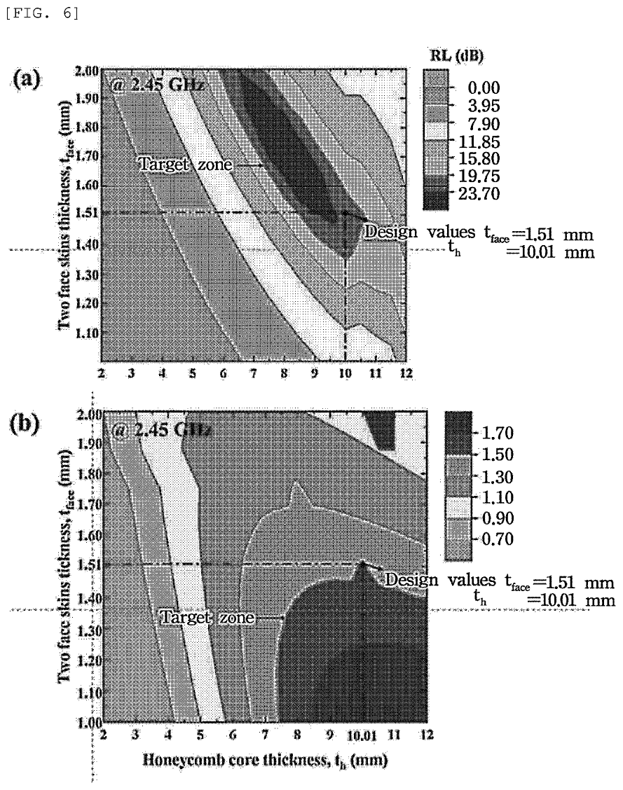

First, the analysis results for electromagnetic wave absorption performance and power loss density considering the honeycomb core wall thickness are shown in FIGS. 5(a) and 5(b). As the honeycomb core wall thickness increased, there was little change in power loss density, and the frequency at which maximum electromagnetic wave absorption performance was shown moved to low frequencies.

The target frequency of the present disclosure is 2.45 GHz, and it was designed with a honeycomb core wall thickness of 0.25 mm, which shows the maximum electromagnetic wave absorption performance at 2.45 GHZ. The analysis results for electromagnetic wave absorption performance and power loss density considering the length of one surface of the honeycomb core are shown in FIGS. 5(c) and 5(d). As the length of one surface of the honeycomb core increased, the frequency at which the maximum electromagnetic wave absorption performance was shown moved to high frequencies, and the power loss density decreased. This is because as the length of one surface of the honeycomb core increases, the size of the honeycomb core increases, and thus the area of the heating element that causes multiple scattering of electromagnetic waves decreases. Therefore, it was designed at 6 mm considering structural applicability.

The analysis results for electromagnetic wave absorption performance and power loss density considering the honeycomb core thickness are shown in FIGS. 5(e) and 5(f). As the honeycomb core thickness increased, there was little change in power loss density, but the frequency at which the maximum electromagnetic wave absorption performance was shown increased. Therefore, it was designed with a honeycomb core thickness of 10 mm which exhibits maximum electromagnetic wave absorption performance at the target frequency of 2.45 GHZ.

The thickness of the face skin of the sandwich composite and the thickness of the honeycomb core were designed using a genetic algorithm based on the designed honeycomb core. Considering the electromagnetic wave absorption performance and power loss density of the sandwich composite, the thickness of the face skin is 1.51 mm, and the thickness of the honeycomb core is 10.01 mm. The analysis results for electromagnetic wave absorption performance and power loss density are shown in FIGS. 6(a) and 6(b).

FIG. 4 shows a modeling design diagram of a unit shape for optimal shape design for determining the thickness of the face skin according to an embodiment of the present disclosure.

The heating object of the present disclosure is a multi-functional heating sandwich composite. The material used is metal electroless plated dielectric fiber/epoxy, and the configuration is as follows.

Top face skin: 100 mm (width)×100 mm (length)×1.51 mm (thickness)

Honeycomb core: 100 mm (width)×100 mm (length)×10.01 mm (thickness), (cell shape=0.25 mm (wall thickness), 6 mm (length of one surface of core))

Bottom face skin: 100 mm (width)×100 mm (length)×1.51 mm (thickness)

Since the multi-functional heating sandwich composite is heated up to 160.06° C. and does not decrease in strength after it is heated, the present disclosure includes a multi-functional heating sandwich composite structure in which a decrease in structural strength due to heating does not occur.

FIG. 5 shows radio wave absorption performance (a) according to the honeycomb core wall thickness, power loss density (b) according to the honeycomb core wall thickness, radio wave absorption performance (c) according to the length of one surface of the honeycomb core, power loss density (d) according to the length of one surface of the honeycomb core, radio wave absorption performance (e) according to the honeycomb core thickness, and power loss density (f) according to the honeycomb core thickness, as matters related to the shape design of the honeycomb core according to an embodiment of the present disclosure.

FIG. 6 shows electromagnetic wave absorption performance (a) according to thicknesses of the top and bottom face skins and the honeycomb core, and power loss density (b) according to thicknesses of the top and bottom face skins and the honeycomb core according to an embodiment of the present disclosure.

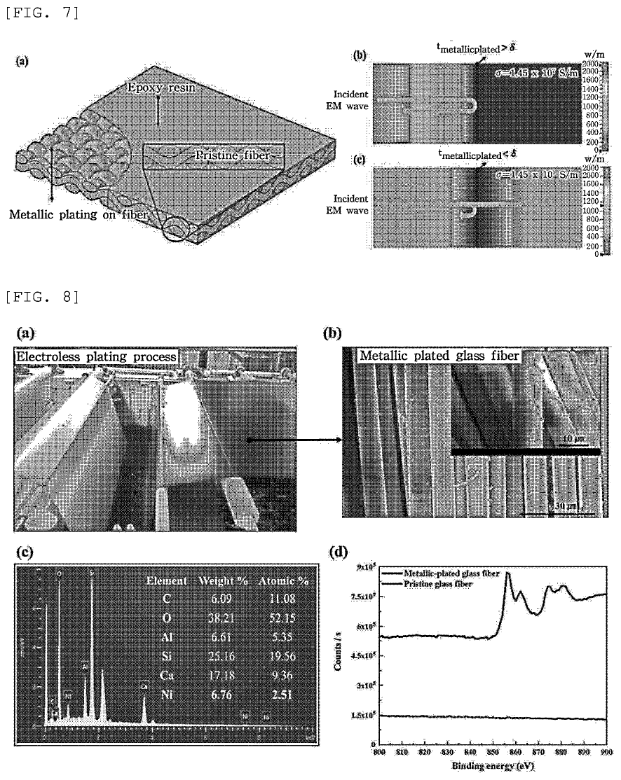

FIG. 7 shows an electromagnetic wave analysis model and electromagnetic wave analysis results of a metal electroless plated dielectric fiber according to an embodiment of the present disclosure (a), t_{metallic-plated}>δ (b), and t_{metallic-plated}<δ (c).

The dielectric loss material is a material in which when an external electromagnetic wave is applied to the dielectric loss material, an internal electromagnetic wave is generated due to polarization in which the dipoles within the dielectric loss material are aligned, and thus the external electromagnetic wave is lost.

When an electromagnetic wave whose phase changes periodically is applied to a dielectric loss material, polarization inside the dielectric loss material is repeatedly induced so that collision and friction between dipoles occur. This causes the dielectric loss material to generate heat. In order to induce dielectric heating in metal electroless plated dielectric fibers, electromagnetic waves should penetrate into the metal electroless plated dielectric fibers.

In order for electromagnetic waves to penetrate metal electroless plated dielectric fibers, the skin depth (δ) should be thicker than the physical thickness of the metal layer. Accordingly, electromagnetic wave analysis was performed to select the appropriate skin depth. FIG. 7(a) shows the shape of the model for obtaining the skin depth.

FIGS. 7(b) and 7(c) show the results of performing electromagnetic wave analysis by taking electrical conductivity into consideration to select an appropriate skin depth. As results of the analysis, it was confirmed that electromagnetic waves may penetrate into the metal electroless plated dielectric fibers when the electrical conductivity of the metal electroless plated dielectric fibers should be at the level of 14.5 S/m.

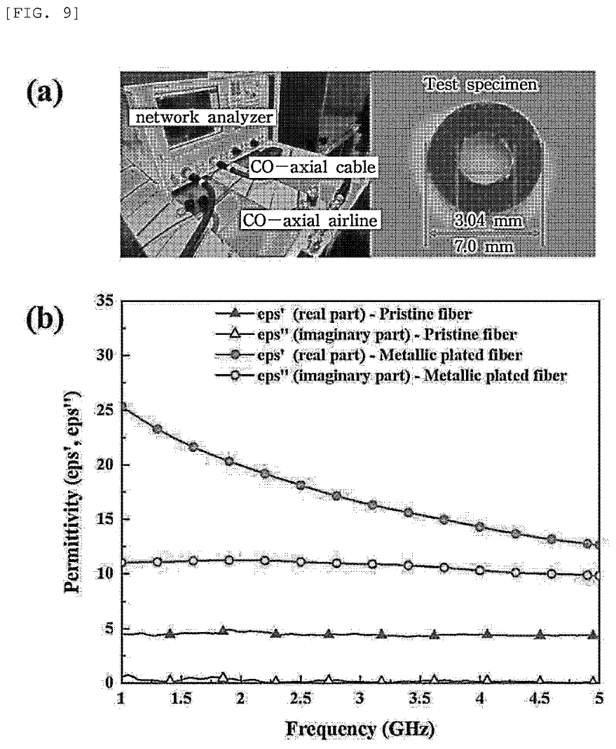

FIG. 8 shows a metal electroless plating process (a), an SEM image (b) of metal electroless plated dielectric fibers, EDS analysis results (c) of the metal electroless plated dielectric fibers, and XPS analysis results (d) of dielectric fibers depending on there is metal electroless plating or not, according to an embodiment of the present disclosure.

FIG. 8(a) shows a metal electroless plating process in which a general dielectric fiber is impregnated in a large water tank containing a metal solution, and thus metal electroless plating is performed on the surface of the dielectric fiber through a redox reaction. A scanning electron microscope (SEM) image was taken of the metal electroless plated dielectric fiber to confirm that metal electroless plating was performed constantly on the surface of the dielectric fiber, and is shown in FIG. 8(b).

In addition, FIG. 8(c) shows that specific metals are detected by detecting characteristic X rays, which are generated by irradiating an electron beam accelerated to 5 to 30 kV to the surface of a metal electroless plated dielectric fiber, with an energy-dispersive X-ray spectroscopy (EDS) that is a dispersive spectrometer, and FIG. 8(d) shows the results of checking whether there is metal electroless plating or not by measuring the kinetic energy of electrons emitted from 1 to 10 mm of the upper portion of the material by spinning X-rays to the surface of the dielectric fiber (XPS (X-ray photoelectron spectroscopy)).

FIG. 9 shows coaxial tube equipment configuration and specimen shape (a) according to an embodiment of the present disclosure, and complex permittivity of the dielectric fiber (b) depending on whether there is metal electroless plating or not.

The complex permittivity of the metal electroless plated dielectric fiber was obtained through coaxial tube equipment, and the configuration and specimen of the coaxial tube equipment and the complex permittivity of the metal electroless plated dielectric fiber are shown in FIGS. 9(a) and 9(b).

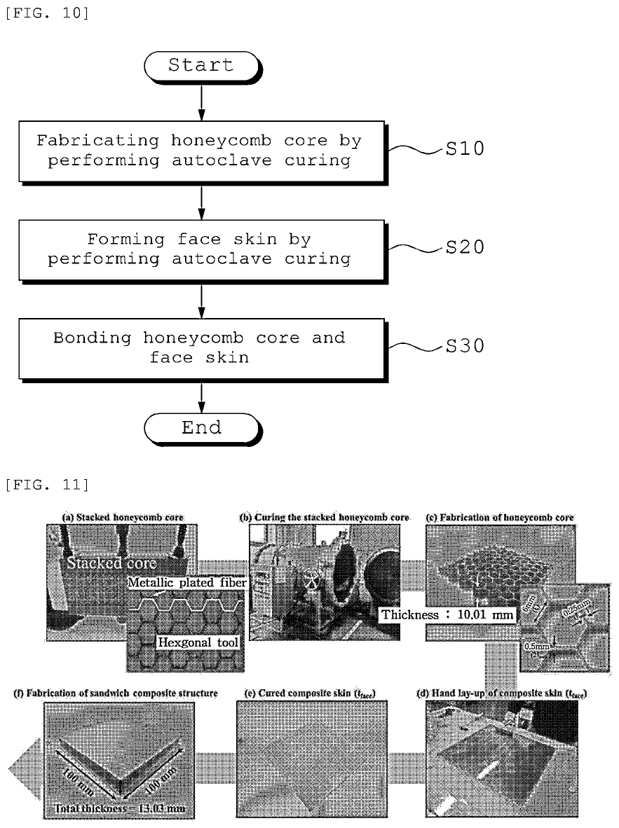

FIG. 10 shows a flowchart of a method for manufacturing a multi-functional heating sandwich composite based on electromagnetic wave absorption technology applicable to large wing structures, according to an embodiment of the present disclosure.

Referring to FIG. 10, the method for manufacturing a multi-functional heating sandwich composite based on electromagnetic wave absorption technology applicable to large wing structures according to an embodiment of the present disclosure may include steps of fabricating a honeycomb core by performing autoclave curing (S10), forming a face skin by performing autoclave curing (S20), and bonding the honeycomb core and the face skin (S30).

In the step (S10) of fabricating a honeycomb core by performing autoclave curing, a plurality of metal electroless plated dielectric fibers are stacked to absorb electromagnetic waves applied from the outside and processed to have a predetermined width, the dielectric fibers are stacked on a hexagonal mold, and then autoclave curing is performed at a temperature of 130° C. or higher and for 2 hours or more.

In the step (S20) of forming a face skin by performing autoclave curing, a plurality of metal electroless plated dielectric fibers are stacked, and then autoclave curing is performed at a temperature of 130° C. or higher and in an environment of 7 atmospheric pressures or higher for 2 hours or more.

The step (S30) of bonding the honeycomb core and the face skin is a process of bonding the face skin to the top or bottom of the honeycomb core.

The designed multi-functional heating sandwich composite was fabricated through the following process. First, in order to fabricate the honeycomb core, two sheets of metal electroless plated dielectric fibers were stacked and then processed to have a width of 25 mm, the metal electroless plated dielectric fibers cut to have a width of 25 mm were stacked on a hexagonal mold, and then a honeycomb core was fabricated by performing autoclave curing in a temperature environment of 130° C. for 2 hours. The fabricated honeycomb core was processed to a designed thickness of 10.01 mam.

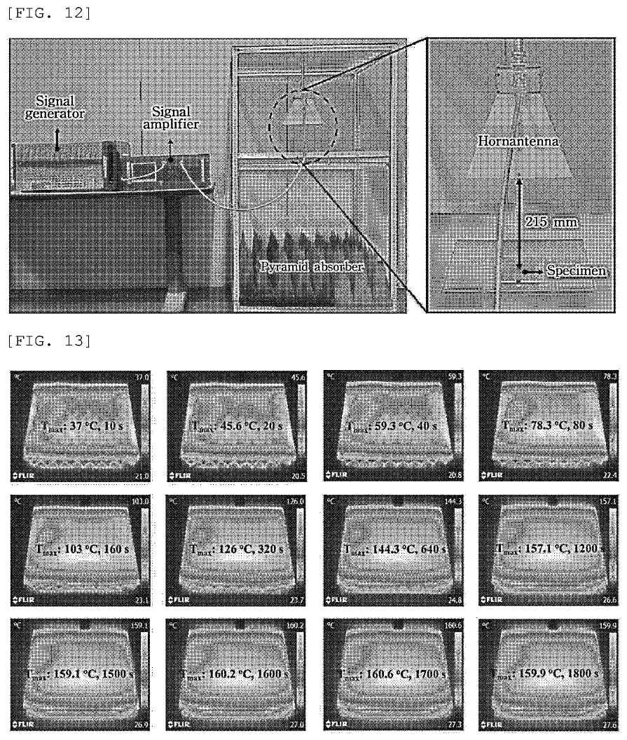

In the case of the face skin, 12 sheets of metal electroless plated dielectric fibers were stacked, and then autoclaved curing was performed for 2 hours in an environment of 130° C. and 7 atmospheric pressures. A multi-functional heating sandwich composite was fabricated by performing secondary adhesion of the honeycomb core and the face skin that are respectively cured using an adhesive, and is shown in FIG. 11.

FIG. 11 shows a process for fabricating a multi-functional heating sandwich composite based on electromagnetic wave absorption technology applicable to large wing structures, according to an embodiment of the present disclosure.

Referring to FIG. 11, it includes the process of FIG. and shows the electromagnetic wave generator and heating test configuration used in the experiment.

FIG. 12 shows an electromagnetic wave generator and heating test setup according to an embodiment of the present disclosure.

A heating test was performed using an electromagnetic wave generator on the multi-functional heating sandwich composite structure fabricated in the present disclosure, and a power of 500 W was applied at a frequency of 2.45 GHZ in the present disclosure.

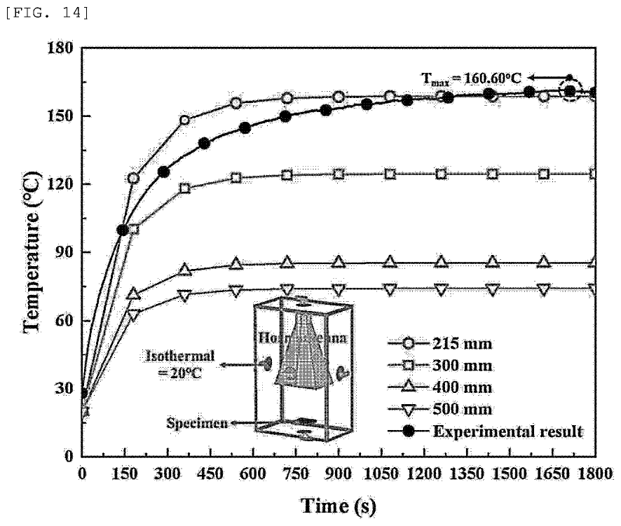

FIG. 13 shows temperature changes over time of a multi-functional heating sandwich composite structure according to an embodiment of the present disclosure.

Referring to FIG. 13, the temperature changes of the multi-functional heating sandwich composite structure were checked through a thermal imaging camera. The structure heating test was performed for 1800 seconds. FIG. 13 shows the temperature changes of the multi-functional heating sandwich composite structure over time.

FIG. 14 shows heating analysis results and heating test results according to the distance between the antenna and the multi-functional heating sandwich composite according to an embodiment of the present disclosure.

Referring to FIG. 14, electromagnetic-thermal multi-physics analysis was performed in order to verify the heating test and check the heating performance according to the distance between the antenna and the multi-functional heating sandwich composite.

As a result of multi-physics analysis, the heating test and analysis results were similarly shown. It was confirmed that the heating performance depending on the distance between the antenna and the multi-functional heating sandwich composite decreases as the distance increases.

FIG. 15 shows test setup and failure mode (a) according to an embodiment of the present disclosure, and compressive strength (b) of the multi-functional heating sandwich composite depending on whether there is a heating test or not.

A compression test was performed in order to check whether there was a change in the structural strength of the multi-functional heating composite depending on whether there was the heating test or not. The test used an MTS E45 universal testing machine with a maximum load of 300 KN, and the test setup and failure mode are shown in FIG. 15(a), and the compressive strength depending on whether there was the heating test or not is shown in FIG. 15(b). The compressive strengths depending on whether there was the heating test or not were 4.05 and 4.01 MPa, respectively, and there was no decrease in strength due to the heating test.

Although the present disclosure has been described in detail through representative embodiments above, those skilled in the art to which the present disclosure pertains will understand that various modifications can be made to the above-described embodiments without departing from the scope of the present disclosure. Therefore, the scope of rights of the present disclosure should not be limited to the described embodiments, but should be determined not only by the claims described later, but also by all changes or modified forms derived from the claims and equivalent concepts.

1. A multi-functional heating sandwich composite based on electromagnetic wave absorption technology applicable to large wing structures, the composite comprising:
a face skin formed to a predetermined thickness on the top or bottom of the composite to absorb electromagnetic waves applied from the outside; and
a honeycomb core that converts the power loss of electromagnetic waves penetrating from the face skin into thermal energy and is formed in the shape of a hexagonal pillar with a predetermined thickness using metal electroless plated dielectric fibers having electrical conductivity,
wherein the honeycomb core reduces reflected electromagnetic waves by dissipating the electromagnetic waves through periodic changes in impedance in a preset target frequency band.

2. The composite of claim 1, wherein the face skin includes: a top face skin installed on the top of the honeycomb core; and a bottom face skin installed on the bottom of the honeycomb core.

3. The composite of claim 2, wherein the top face skin is formed to a width of 100 mm×a length of 100 mm×a thickness of 1.51 mm, the honeycomb core is formed to a width of 100 mm×a length of 100 mm×a thickness of 10.01 mm, and the bottom face skin is formed to a width of 100 mm×a length of 100 mm×a thickness of 1.51 mm.

4. The composite of claim 2, wherein the honeycomb core includes a plurality of cells in the form of hexagonal columns, and the cells have a wall thickness of 0.25 mm and are formed to a width of 6 mm×a length of 10.01 mm.

5. The composite of claim 1, wherein the dielectric fibers are electroless plating-coated to a thickness thinner than the skin depth using at least one metal of nickel (Ni), iron (Fe), and cobalt (Co).

6. A method for manufacturing a multi-functional heating sandwich composite based on electromagnetic wave absorption technology applicable to large wing structures, the method comprising steps of:
stacking a plurality of metal electroless plated dielectric fibers so that they absorb electromagnetic waves applied from the outside and thus processing the plurality of metal electroless plated dielectric fibers to have a predetermined width, and fabricating a honeycomb core by performing autoclave curing at a temperature of 130° C. or higher and for 2 hours or more after stacking the dielectric fibers on a hexagonal mold;
forming a face skin by performing autoclave curing at a temperature of 130° C. or higher and in an environment of 7 atmospheric pressures or higher for 2 hours or more after stacking the plurality of metal electroless plated dielectric fibers; and
bonding the face skin to the top or bottom of the honeycomb core.

7. The method of claim 6, wherein the face skin includes:
a top face skin installed on the top of the honeycomb core; and
a bottom face skin installed on the bottom of the honeycomb core, and
the top face skin is formed to a width of 100 mm×a length of 100 mm×a thickness of 1.51 mm, the honeycomb core is formed to a width of 100 mm×a length of 100 mm×a thickness of 10.01 mm, and the bottom face skin is formed to a width of 100 mm×a length of 100 mm×a thickness of 1.51 mm.

8. The method of claim 6, wherein the temperature control of the composite is performed by adjusting the distance between an antenna of the composite and the composite.

9. The method of claim 6, wherein only an area where electromagnetic waves are absorbed is heated.

10. The composite of claim 3, wherein the honeycomb core includes a plurality of cells in the form of hexagonal columns, and the cells have a wall thickness of 0.25 mm and are formed to a width of 6 mm×a length of 10.01 mm.
